(19) United States
(12) Patent Application Publication
(10) Pub. No.: US 2002/0188705 A1
(43) Pub. Date: Dec. 12, 2002

(54) Method for configuring multiple user systems using a configuration device

(76) Inventors: Roland Bartussek, Augsberg (DE); Alec Miloslavsky, Hillsborough, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/954,359

(22) Filed: Sep. 12, 2001

Related U.S. Application Data
(60) Provisional application No. 60/297,640, filed on Jun. 11, 2001.

(51) Int. Cl. G06F 15/16; G06F 15/177

(52) U.S. Cl. 709/221; 709/203; 709/220

(57) ABSTRACT

A method for receiving input into a configuration device, configuring a first system according to a first input provided by a first user, configuring a second system according to a second input provided by a second user, and dynamically updating a first set of components in the first system and a second set of components in the second system using the configuration device, such that the configuration of the first system is maintained according to the first user input and the configuration of the second system is maintained according to the second user input is disclosed. In one embodiment, the dynamic updating of the systems occurs when a change needs to be made to the components within the systems. In one embodiment, the configuration device allows for interactive refinement of the configuration of the multiple systems by the multiple users. In alternative embodiments,

The present application claims priority to the provisional filed application entitled Multiuser, Multisoftware Configuration Tool for Realtime Configuration of Multiple Accounts and Multiple User Systems, filed on Jun. 11, 2001, Ser. No. 60/297,640, which is also incorporated herein by reference.

### FIELD OF THE INVENTION

The present invention relates to the field of systems configuration.

### BACKGROUND OF THE INVENTION

When complex information technology (IT) systems are employed, they often require correspondingly complicated configuration tools. Typically, complex IT systems consist of a plurality of computers with software instances (e.g., copies of the same program/application being run) running on several of the computers. When one of the software instances are changed, matching changes in other software instances throughout the system are also required. Thus, a new breed of tools has evolved that allows configuration of multiple software instances at once. The concurrent software instance configuration allows necessary changes to be made throughout the system of multiple computers, instead of each instance being configured individually and the changes being made one at a time.

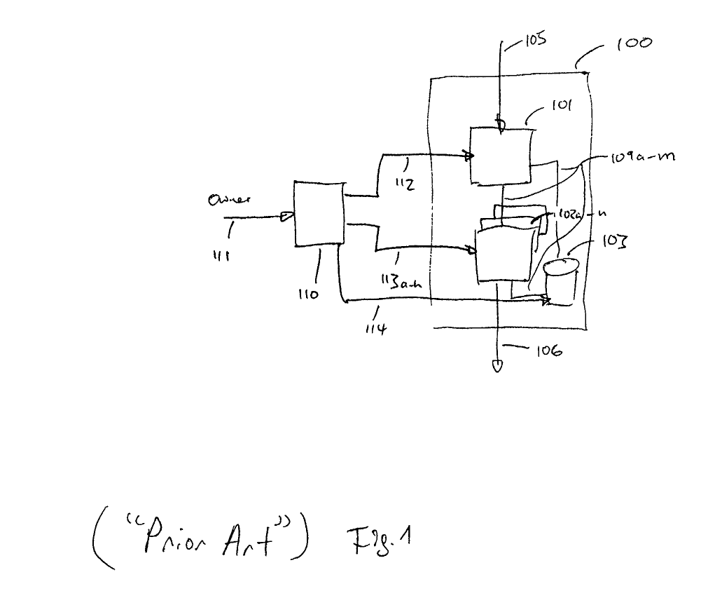

FIG. 1 illustrates an overview of the type of complex IT system known in the prior art. The system 100 consists of multiple software instances 101 and 102a-n. A generic input component 105 brings input into the system from the outside, and a generic output component 106 returns results to the outside. A database 103 is incorporated into the system and is connected to the software instances 101 and 102a-n through internal interconnections 109a-n.

When a configuration change is required within the system, many of the components, such as the software instances 101 and 102a-n, the database 103, the input component 105, the output component 106, and the internal interconnections 109a-n may be affected. Therefore, a configuration tool 110 may be used that allows changes to be made with a single input 111, instead of having to go into each component 101, 102a-n, 103, 105, 106 and 109a-n and manually reconfigure them all. The configuration tool 110 allows a single input 111 to effectuate changes in multiple components 101, 102a-n, 103, 105, 106 and 109a-n through connections 112, 113a-n and 114 that connect to the software instances 101 and 102a-n and the database 103. Use of the configuration tool 110 is necessary because the different software instances 101 and 102a-n may have been written with different tools, different software languages, or different operating systems. There may also be other structural differences between the software instances.

A major problem with the system 100 shown in FIG. 1 is that multiple users may each require different configurations, according to the user's preferences. Multiple reconfiguration of a system can become an enormous, ongoing task. Further, if multiple systems are used, such that each user may set his own parameters and his own configuration methods, it may be very difficult to manage multiple reconfigurations of multiple systems at the same time. Each system would therefore have to be reconfigured one at a time, requiring a great deal of effort and time to be spent implementing the multiple reconfiguration.

What is needed is a system and method that allow configuration of multiple systems, where some of the systems may be shared by multiple users, while still allowing each user to have his own system configuration that may be dynamically updated as needed.

### SUMMARY OF THE INVENTION

In one embodiment, a method for receiving input into a configuration device, configuring a first system according to a first input provided by a first user, configuring a second system according to a second input provided by a second user, and dynamically updating a first set of components in the first system and a second set of components in the second system using the configuration device, such that the configuration of the first system is maintained according to the first user input and the configuration of the second system is maintained according to the second user input is disclosed. The dynamic updating of the systems occurs when a change needs to be made to the components within the systems, according to one embodiment. Further, the configuration device allows for interactive refinement of the configuration of the multiple systems by the multiple users, according to one embodiment.

In one embodiment, the configuration device is provided by an application service provider site. In another embodiment, the configuration device resides within each system.

### BRIEF DESCRIPTION OF THE INVENTION

The present invention will be described by way of exemplary embodiments, but not limitations, illustrated in the accompanying drawings in which like references denote similar elements, and in which:

FIG. 1 is an illustration of the Prior Art in which a configuration device is employed by a user to reconfigure components of a system.

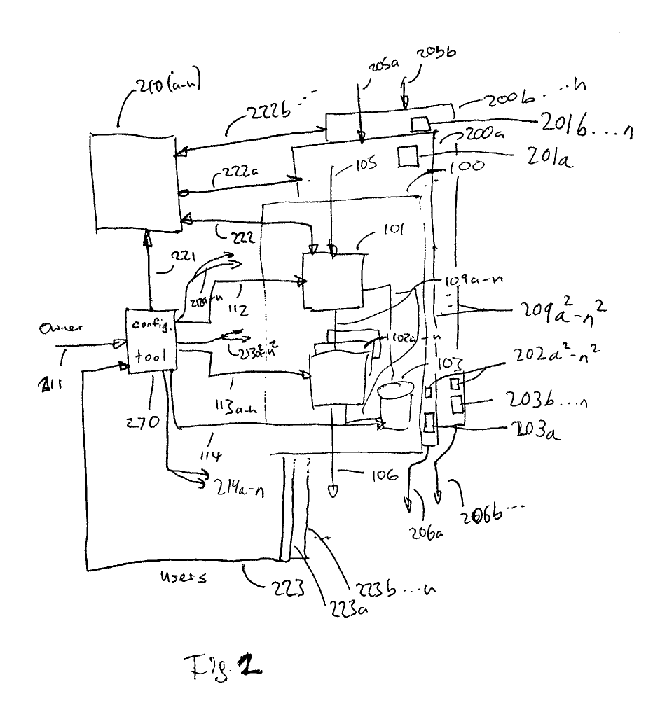

FIG. 2 is an illustration of a plurality of systems being connected to a configuration device that allows components of the systems to be reconfigured, according to one embodiment.

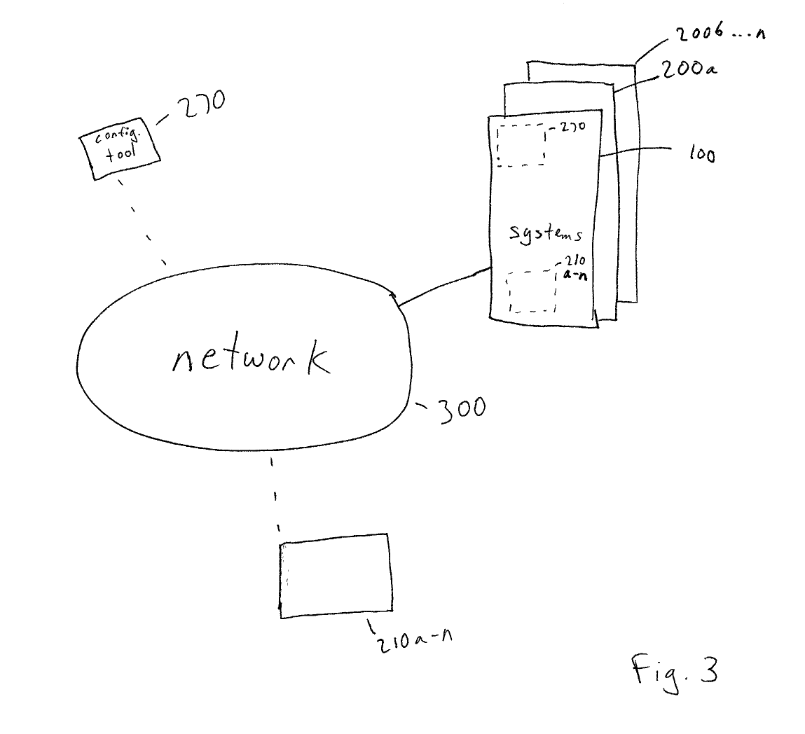

FIG. 3 is an illustration of a network, over which a plurality of systems are connected to a configuration device that allows components of the systems to be reconfigured, according to one embodiment.

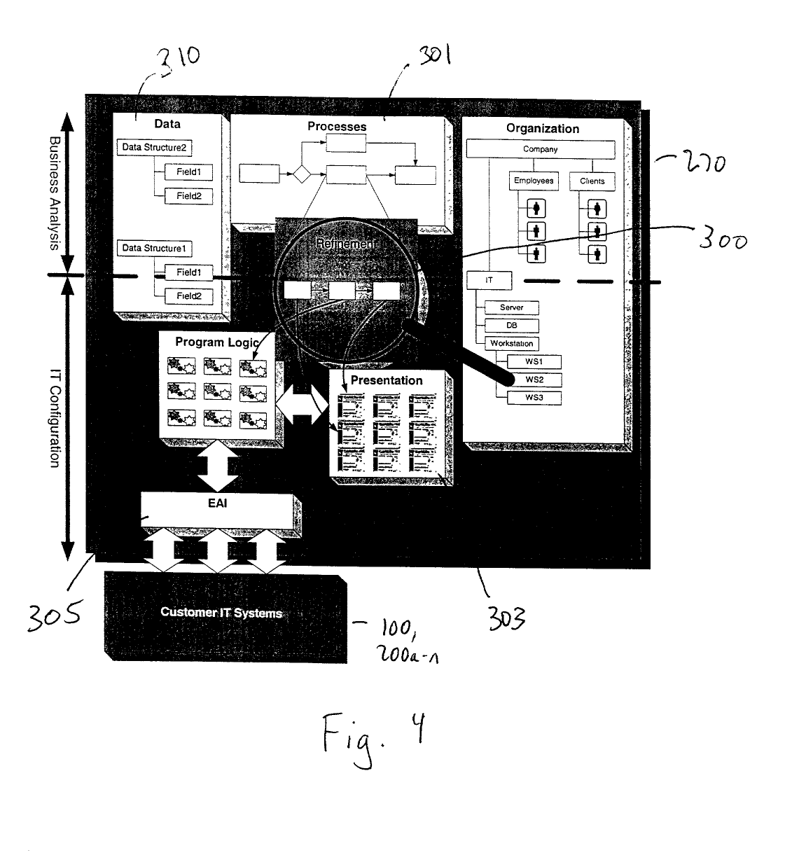

FIG. 4 is a block diagram illustrating an overview of the internal workings of a configuration tool, according to one embodiment.

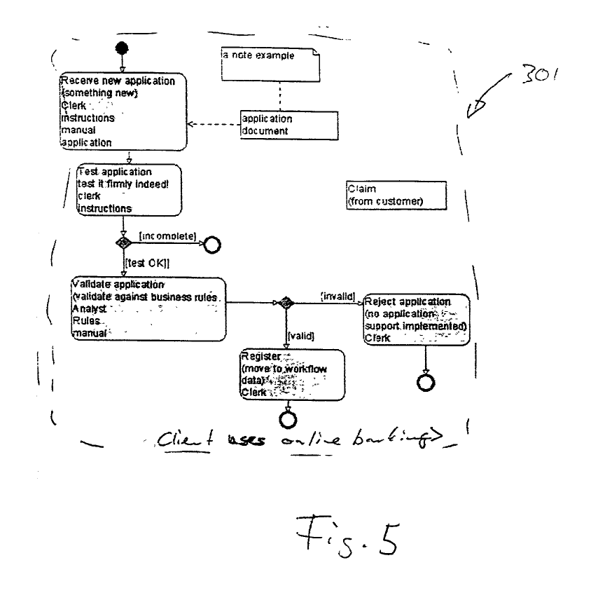

FIG. 5 is a flow diagram illustrating an example of a business process, according to one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific configurations are set forth in order to provide a thorough understanding of the present invention. However, it will also be apparent to one skilled in the art that the present invention may be practiced without the specific details. In other instances, well-known features are omitted or simplified in order not to obscure the present invention.

Referring now to FIG. 2, an overview of a plurality of systems is illustrated—additional systems 200a-n being added to the system 100 of FIG. 1. The multiple systems 100 and 200a-n each are comprised of a plurality of computers. The systems 100 and 200a-n could be, for example, bank data center systems. The multiple systems 100 and 200a-n could each have their own configuration parameters, according to the preferences of a user (e.g., an IT administrator). Within each of the systems 100 and 200a-n are a plurality of components that may vary according to each system.

The plurality of components within each of the systems 100 and 200a-n could be multiple software instances 101, 102a-n, 201a-n and 202a²-n². The systems 100 and 200a-n may contain internal interconnections 109a-n and 209a²-n², between the multiple software instances 101, 102a-n, 201a-n and 202a²-n² within the systems 100 and 200a-n. The systems 100 and 200a-n could contain databases 103 and 203a-n. The systems 100 and 200a-n contain input components 105 and 205a-n and output components 106 and 206a-n.

The systems 100 and 200a-n may share software components 210a-n. The shared software components 210a-n may be run inside the systems 100 and 200a-n, according to one embodiment. In another embodiment, the shared software components 210a-n may be provided by an outside software provider, such as an application service provider (ASP), on an application service provider (ASP) site. The application service provider may be, for example, a credit card acceptance center.

In many situations, multiple systems need to be shared between users so as to provide access to various applications, data and specific software instances. A problem that arises with the sharing of systems is that each time one component within one of the systems is changed, other components throughout the systems may need to be changed as well. Further, specific users of the system (e.g., IT administrators) may want the configuration of their own system to be maintained in a specific way. When changes need to be made, it may take a great deal of time and effort to change all the components according to the reconfiguration (which may be, for example, the addition of a software component), while still maintaining the configuration of the system in the manner in which the system user wants.

A configuration tool 270 is then used to configure parameters within the systems 100 and 200a-n. In one embodiment, the configuration tool 270 includes a graphical user interface that may be used by multiple users and can dynamically reconfigure multiple components within the systems 100 and 200a-n. An example of such a configuration tool 270 is the Exigen™ Configuration Tool™. The configuration tool 270 is connected to the systems 100 and 200a-n through configuration lines 112, 113a-n, 114, 212a-n, 213a²-n² and 214a-n. Configuration lines 112, 113a-n, 212a-n and 213a²-n² connect to software instances 101, 102a-n, 201a-n and 202a²-n². Configuration lines 214a-n connect to the databases 103 and 203a-n.

In one embodiment, the configuration tool 270 also connects to the shared software components 210a-n through connections 221a-n. Users of each of the systems 100 and 200a-n have the ability through their input lines 223 and 223a-n to configure the operation of their own systems. For example, when names are transmitted for credit card transactions, system 100 may require a display such that the last name is first, whereas system 200a may require the first name first. The users for the systems 100 or 200a-n can set the configuration of their system according to their own preferences. Further, the users can configure their systems 100 and 200a-n in conjunction with the software components 210a-n that are controlled through the connections 221a-n. Also, the owner of the system 100 or 200a-n may configure the system according to his requirements through the owner input line 211. In another embodiment, the shared software components 210a-n may also have interconnections among themselves (not shown).

Thus, multiple dynamic configurations may be transmitted from the configuration tool 270 to the IT systems 100 and 200a-n, and each user may see the configuration of his system in a specific way. The software instances will have been configured according to his (or the owner's) specification. Further, the software components 210a-n that are shared among the systems 100 and 200a-n, will appear to each user to be configured according to his requirements, as provided through his input 223a-n. The software components 210a-n may be additionally configured by the owner of the system 100 or 200a-n or by the application service provider (ASP) through the input line 211. Therefore, the services of software components 210a-n may be provided to all the IT systems 100 and 200a-n, each receiving virtual personalized service according to the requirements of the owner or the users. Based on the user group to which the specific user belongs, a specific presentation is shown (which depends on the input 223a-n or 211 provided into the configuration tool 270). The introduction of new software components 210a-n that are shared by the systems 100 and 200a-n is therefore much easier as the necessary reconfiguration of all the software instances, databases and configuration lines within the systems can be done through the one configuration device—the configuration tool 270, while still maintaining the specific presentation requested by each user.

FIG. 3 is an illustration of the multiple systems 100 and 200a-n being connected to a configuration device over a network that allows components within the systems to be reconfigured. The systems 100 and 200a-n are composed of a plurality of computers that may be configured by users (generally a small group of users or a single user, such as an IT administrator or IT administration group) or the owner of the system 100 or 200a-n. The configuration tool 270 could be accessed over the network 300 by the users of the systems 100 or 200a-n. The shared software components 210a-n could be accessed by the systems 100 and 200a-n over the network 300 from either an application service provider (ASP) site or from one of the systems 100 or 200a-n.

The configuration tool 270 may include a database (not shown) that allows for a consistency check across the multiple systems 100 and 200a-n so that the consistency of the configuration of each system 100 or 200a-n is verified. In order to ensure consistency of the configuration of each system 100 or 200a-n, verification is needed when multiple software instances are connected into the systems 100 or 200a-n, such that the instances may be connected while still maintaining the correct configuration of each system 100 or 200a-n according to the requirements and preferences of the system users. The consistency check may apply to software revisions, metadata model compatibility and other similar items that may need consistency checks when they are combined together. The database would contain information on all the users and all the applications and ensure that only the appropriate applications are combined (so that the consistency of the configuration of the systems 100 and 200a-n is maintained). In one embodiment, the database would be local to the configuration tool 270. The database may also, according to one embodiment, be used by the configuration tool 270 for other tasks, including providing security clearance.

A security clearance may be provided for access to specific objects that may be viewed through the interface included in the configuration tool 270. The configuration tool 270 is used to determine the rights that each user has for each object seen in the interface. The configuration tool 270 could, in one embodiment, access a database that identifies specific users and user rights. For example, each user belongs to a specific user group, and each user group has specific rights for certain object types. The configuration tool 270 displays the objects in accordance with the rights of the user (verified through, for example, the database). The access level of specific user groups and the objects assigned to specific access levels may be cross-related, such that every user's specific rights do not have to be entered in detail but instead correspond to the object access level for a group.

Another aspect of the configuration tool is that it allows for the interactive refinement of a business process in order to be able to configure the specific system more accurately. FIG. 4 shows a diagram of the internal workings of the configuration tool 270. Data 310, business logic (processes) 301 and an organizational chart 304 are modeled within the configuration tool 270. A user interface (Presentation) 303, program logic 302, and an interface section 305 (to which the program logic 302 connects) are configured by the configuration tool 270. The program logic 302 contains a part of a work-flow engine. Another part of the work-flow engine may be contained in the presentation layer 303 because many presentations may require work-flow steps to present documents in the correct manner and sequence. The interface section 305 is connected to the other IT systems 100 and 200a-n. The description of the configuration of the presentation 303, program logic 302, and interface section 305 is linked to the business logic 301 modeled in the configuration tool 270. The business logic 301 is in fact built up as the sum of configuration information for the program logic 302 and the presentation logic 303. There may be many different business logic 301 instances, and the business logic 301 may be real-time or non-real-time. Further, the different instances of business logic 301 may include one another as objects, in a multi-layered architecture.

The configuration tool 270 allows users to be able to tune settings and parameters in an easy-to-follow manner in order to refine their specific user systems. For example, a user may want to see how output is presented to a banking customer. The data 310 would be processed by a business process 301 and then be presented at the presentation 303. The user, utilizing the configuration tool 270, would be able to look into each presentation and program logic element involved in the creation of that specific presentation 303. The user may then tune the settings and parameters to suit his specific preferences (refinement).

The refinement of specific parameters, in one embodiment, is shown in the magnification glass 300 in FIG. 4. The configuration tool 270 links different layers of refinements transparently for users. The user is therefore able to look at only one object inside a process 301, instead of having to look at all the elements involved in the refinements. FIG. 5 is a flow diagram illustrating an example 301a of an actual business process. By double-clicking on a shaded box 500, the refinement for that box 500 (object) is shown. For example, if one of the boxes represents a scanning step, then the refinement would be the selection and/or configuration of the scanning device.

The central storage and transparent linkage of information allows users from different user groups (e.g., HTML designers and business analysts) to easily obtain context information from the configuration tool 270 for their tasks. Descriptions of the configuration for individual components contained within systems 100 and 200a-n usually sit distributed on tools and locations belonging to the individual components. Examples of tools are HTML page designers, work-flow builders and business modeling tools. In traditional IT systems, each user or user group responsible for one component knows information only available in a specific tool, but has no easy access to context information. The configuration tool 270 then allows information to be centrally available, such that users from different user groups may access the information.

For the purposes of this disclosure, the actual system hardware and the configuration of the hardware are considered irrelevant on an architectural level. On an application or setup level, however, they may be relevant, although no specifics are shown. Even in cases where some parameters may be hardware or firmware parameters, rather than purely software parameters, their configuration in general is effectuated in the same way: by writing some script, writing some parameters into some registers or memory locations or making other similar changes effectuated by software means. In a few cases, changes may also require the rewriting of drivers or recompiling of kernels, depending on the actual operating system used. Nevertheless, generically, all such configurations can be done in software.

The processes and embodiments as described above can be stored on machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
receiving input into a configuration device;
configuring a first system according to a first input provided by a first user;
configuring a second system according to a second input provided by a second user; and
dynamically updating a first set of components in the first system and a second set of components in the second system using the configuration device, such that the configuration of the first system is maintained according to the first user input and the configuration of the second system is maintained according to the second user input.

2. The method of claim 1, wherein a plurality of software instances may be run within each of the systems.

3. The method of claim 1, wherein the systems and the software instances share a database.

4. The method of claim 3, wherein the database is used to determine a check of the systems to ensure that the systems and the software instances may be shared so as to provide consistent configuration of each system according to the user's preference.

5. The method of claim 1, wherein a security clearance is provided that allows the user to access an object within one of the systems if the user is approved for access.

6. The method of claim 5, wherein a database is used to determine if the user is approved for access to the object.

7. The method of claim 1, wherein the systems share a software instance that is provided by an application service provider (ASP) site.

8. The method of claim 1, wherein the configuration device is provided by an application service provider (ASP) site.

9. The method of claim 1, wherein the configuration device allows the users to interactively refine the configuration of the systems.

10. A machine-readable storage medium tangibly embodying a sequence of instructions executable by the machine to perform a method, the method comprising:
receiving input into a configuration device;
configuring a first system according to a first input provided by a first user;
configuring a second system according to a second input provided by a second user; and
dynamically updating a first set of components in the first system and a second set of components in the second system using the configuration device, such that the configuration of the first system is maintained according to the first user input and the configuration of the second system is maintained according to the second user input.

11. The machine-readable medium of claim 10, wherein a plurality of software instances may be run within each of the systems.

12. The machine-readable medium of claim 10, wherein the systems and the software instances share a database.

13. The machine-readable medium of claim 12, wherein the database is used to determine a check of the systems to ensure that the systems and the software instances may be shared so as to provide consistent configuration of each system according to the user's preference.

14. The machine-readable medium of claim 10, wherein a security clearance is provided that allows the user to access an object within one of the systems if the user is approved for access.

15. The machine-readable medium of claim 14, wherein a database is used to determine if the user is approved for access to the object.

16. The machine-readable medium of claim 10, wherein the systems share a software instance that is provided by an application service provider (ASP) site.

17. The machine-readable medium of claim 10, wherein the configuration device is provided by an application service provider (ASP) site.

18. The machine-readable medium of claim 10, wherein the configuration device allows the users to interactively refine the configuration of the systems.

19. A system comprising:
a unit able to receive input;
a first operation center configured according to a first input provided by a first user;
a second operation center configured according to a second input provided by a second user; and
a first set of components in the first system and a second set of components in the second system being dynamically updated by the unit, such that the configuration of the first operation center is maintained according to the first user input and the configuration of the second operation center is maintained according to the second user input.

20. The system of claim 19, wherein a plurality of software instances may be run within each of the systems.

21. The system of claim 19, wherein the systems and the software instances share a database.

22. The system of claim 21, wherein the database is used to determine a check of the systems to ensure that the systems and the software instances may be shared so as to provide consistent configuration of each system according to the user's preference.

23. The system of claim 19, wherein a security clearance is provided that allows the user to access an object within one of the systems if the user is approved for access.

24. The system of claim 23, wherein a database is used to determine if the user is approved for access to the object.

25. The system of claim 19, wherein the systems share a software instance that is provided by an application service provider (ASP) site.

26. The system of claim 19, wherein the configuration device is provided by an application service provider (ASP) site.

27. The system of claim 19, wherein the configuration device allows the users to interactively refine the configuration of the systems.
